(19) United States
(12) Patent Application Publication
(10) Pub. No.: US 2003/0210948 A1
(43) Pub. Date: Nov. 13, 2003

(54) Notebook with supplemental bound component

(76) Inventor: Bobby G. James JR., Miamisburg, OH (US)

Correspondence Address: MARK P. LEVY, ESQ., THOMPSON HINE & FLORY LLP, 2000 COURTHOUSE PLAZA NE, 10 W. SECOND STREET, DAYTON, OH, 45402-1758, US

(21) Appl. No.: 10/140,269

(22) Filed: May 7, 2002

(51) Int. Cl. B42F 3/06

(52) U.S. Cl. 402/57

(57) ABSTRACT

A notebook including a first set of papers, the first set of papers including a plurality of sheets of paper, at least one cover, and a primary binding mechanism binding the first set of papers to the cover. The notebook further includes a second set of papers, the second set of papers including a plurality of sheets of paper, and a secondary binding mechanism binding the second set of papers to the cover. At least one paper of the second set of papers can be interleaved with the first set of papers.

The present invention is directed to a notebook, and more particularly, to a notebook with a supplemental bound component.

### BACKGROUND OF THE INVENTION

Notebooks are widely used by students, professionals and other users as a device for carrying papers. Such notebook may also include various pockets for storing loose papers and other items. Users often utilize separate notebooks for different subjects or different uses, and may also use various place holders or bookmarks for marking locations in the notebooks. Accordingly, there is a need for a notebook which includes a supplemental bound component, and which, in one embodiment, includes pages which can serve as a place holder.

### SUMMARY OF THE INVENTION

The present invention is a notebook with a supplemental bound component. In one embodiment, the notebook includes a “main” or primary bound component and a “supplemental” or secondary bound component. In this manner, the invention provides two separate notebooks which are bound together for ease of use and transportation, and for complementary use. In one embodiment, the pages of the supplemental bound component can be interleaved with the pages of the primary bound component.

In one embodiment, the invention is a notebook comprising a first set of papers, the first set of papers including a plurality of sheets of paper, at least one cover, and a primary binding mechanism binding the first set of papers to the cover. The notebook further includes a second set of papers, the second set of papers including a plurality of sheets of paper, and a secondary binding mechanism binding the second set of papers to the cover. At least one paper of the second set of papers can be interleaved with the first set of papers.

Other objects and advantages will be apparent from the following description and the appended claims.

### BRIEF DESCRIPTION OF THE DRAWINGS

FIG. 1 is a front perspective view of one embodiment of the notebook of the present invention;

FIG. 2 is a front view of the notebook of FIG. 1;

FIG. 3 is a front view of the notebook of FIG. 1, with the primary front cover in its open position;

FIG. 4 is a front view of the notebook of FIG. 3, with the secondary front cover in its open position;

FIG. 5 is an end view of the notebook of FIG. 1; and

FIG. 6 is an end view of the notebook of FIG. 5, with the pages of the supplemental bound component interleaved with the pages of the primary bound component.

### DETAILED DESCRIPTION

The present invention is a notebook 10 which may include a main or primary component 12 and a secondary or supplemental component 14. The notebook 10 may include a primary binding mechanism 16 which binds a first set of sheets of paper 18 together. The primary binding mechanism 16 may be a coil or spiral binding mechanism or a double wire binding mechanism (together a “wire binding mechanism”) which enables the sheets 18 bound therein to travel entirely or nearly entirely around the binding mechanism 16. For example, in one embodiment, each of the sheets 18 bound together by the primary binding mechanism 16 can travel at least about 270°, and up to 360°, around the primary binding mechanism 16. However, the primary binding mechanism 16 is not limited to a wire binding mechanism, but can also be nearly any mechanism for binding a plurality of sheets together, such as an adhesive binding system, prong sets, clips, three-ring-binders, and other similar or well known mechanisms.

The primary component 12 may also include a primary front cover 20 and a back cover 22, and the primary binding mechanism 16 preferably binds the primary front cover 20 and the back cover 22 together. When the notebook 10 is in its closed position, the first set of sheets 18 may be located between the primary front cover 20 and back cover 22. The primary front cover 20 and back cover 22 are preferably made of relatively rigid rectangular pieces of sheet-like material.

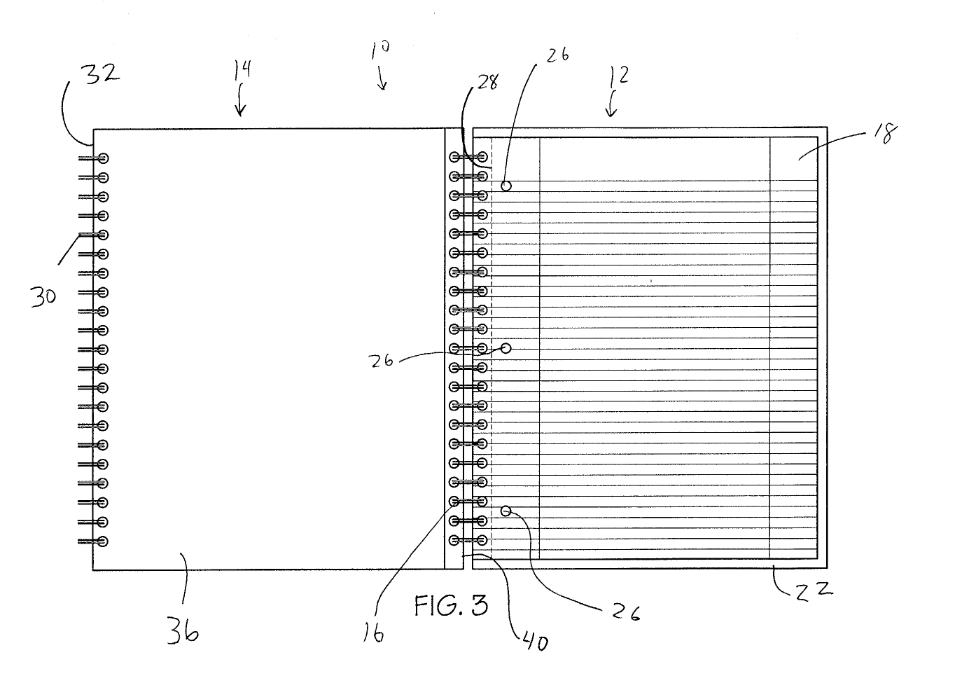

As shown in FIG. 3, each of the first set of sheets of paper 18 may include a plurality of writing guide lines located thereon, and may include a set of three spaced holes 26 such that each of the sheets 18 can be attached to a standard three-ring binder. Each of the sheets 18 may also include a perforation or tear line 28 extending along the inner longitudinal edge of each of the sheets 18 and adjacent to the primary binding mechanism 16 such that each sheet 18 can be torn along its tear line 28 and thereby be separated from the primary binding mechanism 16.

The binder 10 may include a secondary or supplemental binding mechanism 30 coupled to an outer edge 32 of the primary front cover 20. The secondary binding mechanism 30 may also be a coil, spiral, adhesive or other type of binding mechanism, such as the options listed above for the primary binding mechanism 16.

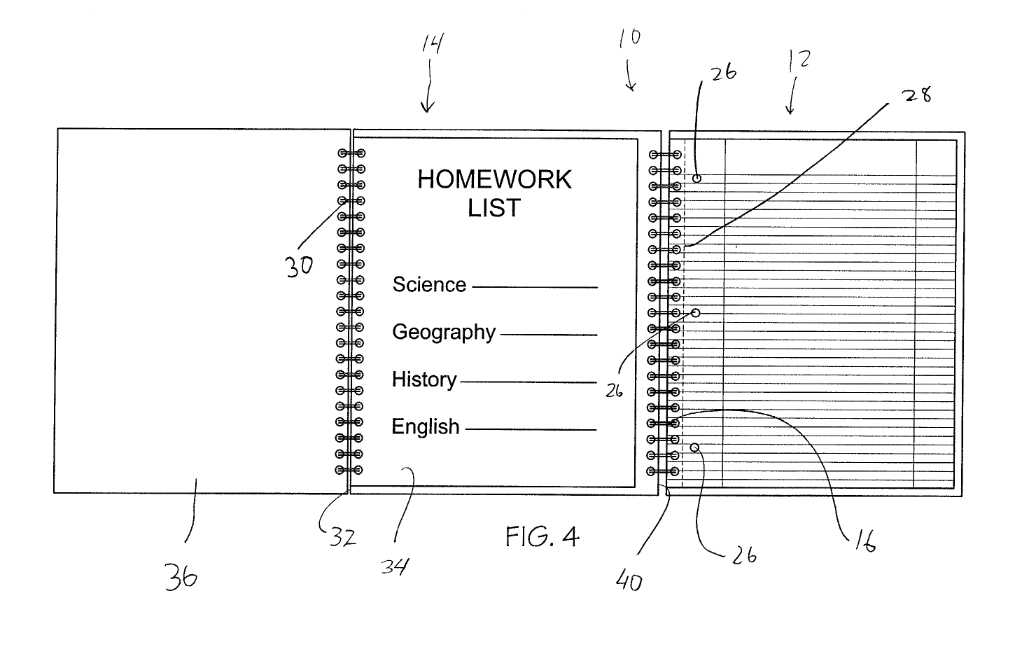

The secondary binding mechanism 30 may be bound to a second or supplemental set of sheets of paper 34 and to a secondary or supplemental front cover 36 to form the secondary component 14. In the illustrated embodiment, the front cover 20 is generally rectangular in front view, and the primary binding mechanism 16 is coupled to an inner edge 40 of the cover 20 and the secondary binding mechanism 30 is coupled to the opposed outer edge 32 of the cover 20. In this manner, the second set of sheets of paper 34 can be located between the primary front cover 20 and secondary front cover 36. Once the primary front cover 20 is opened (FIG. 3), the secondary front cover 36 can be opened to expose and provide access to the second sheets of paper 34 (FIG. 4). Each of the sheets of the first 18 and second 34 sheets of paper and the covers 20, 22, 36 may all have approximately the same size in front view.

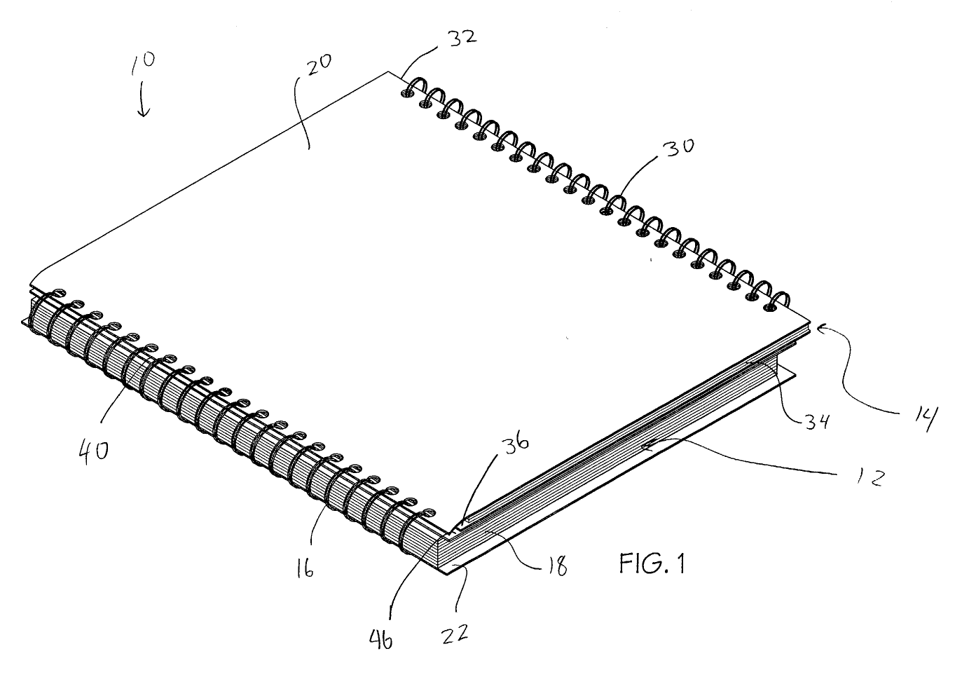

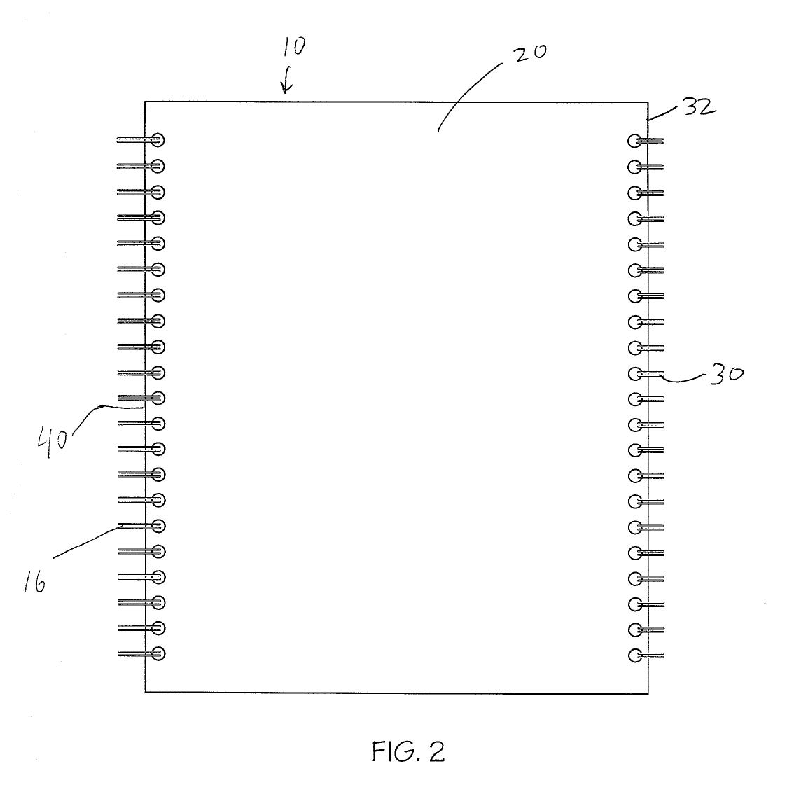

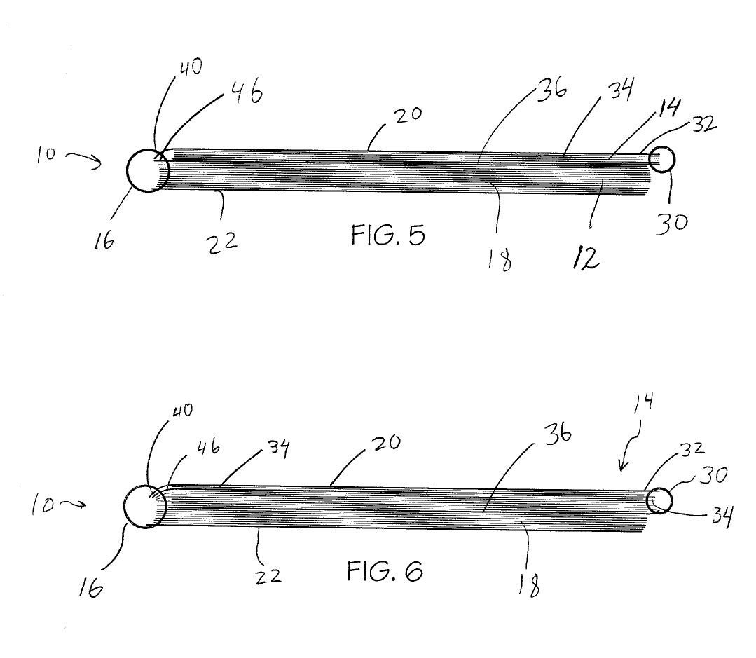

Each of the second sheets of paper 34 may include indicia thereon that can be the same as, or different from, the indicia on the first set of sheets of paper. In the embodiment illustrated in FIG. 4, each of the second sheets of paper 34 includes a homework list such that a student can keep track of his or her homework assignments. However, the second set of sheets of paper 34 may also include various other indicia printed thereon, such as a calendar, planner, lists, reminders, tables, formulas and the like, or any other desired printed indicia, or even blank sheets. If desired, the second sheets of paper 34 may also each include holes and perforations (not shown) similar to the first sheets of paper 18. Both the primary 16 and secondary 30 binding mechanisms may also bind together various other components besides paper. For example, FIGS. 1 and 5 illustrate an additional component, such as a divider pocket 46, bound to the primary binding mechanism 16 and located on top of the first set of sheets of paper 18.

As shown in FIG. 6, each sheet of the second set of sheets of paper 34 may be able to be interleaved with the first set of sheets of paper 18. In this manner, the sheets 34 of the supplemental component 14 can serve as a bookmark or place holder in the sheets 18 of the primary component 12 (or vice versa) at a desired location. For example, if the sheets 34 of the supplemental component 12 is a homework list which indicates that the user has homework in science class, the appropriate sheet of the second set of sheets 34 of paper can be located at the appropriate location of the primary component 12 (for example, at the user's notes for science class for that date). Similarly, if the supplemental component 14 is a calendar, the pages of the calendar can be interleaved at the location of the primary component 12 which includes entries which may correspond to an entry on the associated page of the calendar. Thus, the interleaving capability enables the sheets of the primary 12 and secondary 14 components to provide a variety of interacting and complementary functions. Of course, a wide variety of materials or pages for the primary 12 and supplemental 14 components may be used without departing from the scope of the invention, and.

Having described the invention in detail and by reference to the preferred embodiments, it will be apparent that modifications and variations thereof are possible without departing from the scope of the invention.

What is claimed is:

1. A notebook comprising:
a first set of papers, said first set of papers including a plurality of sheets of paper;
at least one cover;
a primary binding mechanism binding said first set of papers to said cover;
a second set of papers, said second set of papers including a plurality of sheets of paper; and
a secondary binding mechanism binding said second set of papers to said cover, wherein at least one paper of said second set of papers can be interleaved with said first set of papers.

2. The notebook of claim 1 wherein said cover is a relatively rigid piece of sheet-like material.

3. The notebook of claim 1 wherein at least one of said binding mechanisms is a wire binding mechanism.

4. The notebook of claim 1 wherein both of said binding mechanisms are wire binding mechanisms.

5. The notebook of claim 1 wherein each of said sheets of said first and second sets of sheets and said cover have approximately the same size in front view.

6. The notebook of claim 1 wherein said cover is generally rectangular in front view, and wherein said primary binding mechanism is located at or adjacent to one edge of said cover and wherein said secondary binding mechanism is located at or adjacent to an opposite edge of said cover.

7. The notebook of claim 1 further comprising a back cover coupled to said primary binding mechanism such that said first set of papers can be located between said back cover and said at least one cover.

8. The notebook of claim 1 further including a secondary front cover coupled to said secondary binding mechanism such that said second set of papers can be located between said at least one cover and said secondary front cover.

9. The notebook of claim 8 further including a rear cover coupled to said primary binding mechanism such that said first set of papers can be located between said at least one cover and said rear cover.

10. The notebook of claim 1 wherein each of said first set of papers and said second set of papers include indicia printed thereon, and wherein the indicia printed on said first set of papers differs from the indicia printed on said second set of papers.

11. The notebook of claim 10 wherein the indicia printed on said first set of papers includes guide lines, and wherein the indicia printed on said second set of papers includes a calender, a homework guide or planner.

12. The notebook of claim 1 wherein each sheet of said first and second set of papers can rotate at least about 270 degrees about its associated binding mechanism.

13. A notebook comprising:
a first set of papers, said first set of papers including a plurality of sheets of paper;
at least one cover, said cover being a relatively rigid piece of sheet-like material;
a primary binding mechanism binding said first set of papers to said cover;
a second set of papers, said second set of papers including a plurality of sheets of paper; and
a secondary binding mechanism binding said second set of papers to said cover.

14. A notebook comprising:
a first set of papers, said first set of papers including a plurality of sheets of paper;
at least one cover;
a primary binding mechanism binding said first set of papers to said cover;
a second set of papers, said second set of papers including a plurality of sheets of paper; and
a secondary binding mechanism binding said second set of papers to said cover, wherein at least one of said binding mechanisms is a wire binding mechanism.

15. The notebook of claim 14 wherein both of said binding mechanisms are wire binding mechanisms.

16. A notebook comprising:
a first set of papers, said first set of papers including a plurality of sheets of paper;
at least one cover;
a primary binding mechanism binding said first set of papers to said cover;
a second set of papers, said second set of papers including a plurality of sheets of paper; and
a secondary binding mechanism binding said second set of papers to said cover, wherein each of said sheets of said first and second sets of papers and said cover have about the same size in front view.
